(19) United States
(12) Patent Application Publication
(10) Pub. No.: US 2009/0102868 A1
(43) Pub. Date: Apr. 23, 2009

(54) METHOD AND APPARATUS FOR DYNAMICALLY ADJUSTING RESOLUTION OF DISPLAY DEVICE IN MOBILE COMPUTING DEVICES

(75) Inventor: Jon L. SCHINDLER, Glenview, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/877,218

(22) Filed: Oct. 23, 2007

(51) Int. Cl. G09G 5/00

(52) U.S. Cl. 345/698

(57) ABSTRACT

A method and apparatus for dynamically selecting one of plurality of resolutions for display in a mobile computing device is disclosed. The method may include determining at least one of a media type of the visual media file and an image height and an image width of the visual media file, determining whether an energy level of the mobile computing device is a normal energy level or a low energy level, selecting a first one of the plurality of resolutions as the display resolution for display of the visual content file, the first one of the plurality of display resolutions being selected based on the determined at least one of the media type of the visual media file and the image height and the image width of the visual media file, if the energy level is determined to be the normal energy level, and selecting a second one of the plurality of resolutions as the display resolution for display of the visual content file, if the energy level is determined to be the low energy level, wherein the first one of the plurality of resolutions is a higher resolution than the second one of the plurality of resolutions.

### BACKGROUND OF THE INVENTION

1. Field of the Invention

The invention relates to mobile computing devices, and in particular, to dynamically adjusting resolution of a display device in such a mobile computing device.

2. Introduction

Mobile computing devices, such as cellular phones, handheld computers, MP3 players, laptop computers, and the like are very pervasive computing devices. The mobile computing devices provide various features, such as communications, computing features, Internet access, playing music or video, viewing images, etc. Such mobile computing devices will often include a display, such as an LCD (liquid crystal display).

New applications are being developed for such mobile computing devices. In the past, such mobile computing devices, when they included a display, often had a display with a relatively low resolution. However, it is becoming increasingly desirable to provide the mobile computing devices with a display having a higher resolution. This creates a more visually enjoyable viewing experience for the user.

A mobile computing device provided with such an increased resolution display having more pixels will expend more energy to create the images to show on the display and to drive the data to the display. This increased energy consumption will further challenge the supply of energy to such mobile computing devices that are typically battery-powered. The added energy demand may render a high-resolution display unsuitable for use with such mobile computing devices, because users may not tolerate the shorter battery life that results. Further, the user may not require a high resolution display at all times.

### SUMMARY OF THE INVENTION

A method and apparatus for dynamically selecting one of a plurality of resolutions for display in a mobile computing device is disclosed. The method may include determining at least one of a media type of the visual media file and an image height and an image width of the visual media file, determining whether an energy level of the mobile computing device is a normal energy level or a low energy level, selecting a first one of the plurality of resolutions as the display resolution for display of the visual content file, the first one of the plurality of display resolutions being selected based on the determined at least one of the media type of the visual media file and the image height and the image width of the visual media file, if the energy level is determined to be within the normal energy level, and selecting a second one of the plurality of resolutions as the display resolution for display of the visual content file, if the energy level is determined to be the low energy level, wherein the first one of the plurality of resolutions is a higher resolution than the second one of the plurality of resolutions.

### BRIEF DESCRIPTION OF THE DRAWINGS

In order to describe the manner in which advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a mobile computing device in accordance with a possible embodiment of the invention;

FIG. 2 illustrates a block diagram of an exemplary mobile computing device in accordance with a possible embodiment of the invention;

FIG. 3 illustrates an exemplary block diagram of an exemplary mobile computing device in accordance with a possible embodiment of the invention; and

FIG. 4 is an exemplary flowchart illustrating dynamic selection of display resolution in a mobile computing device in accordance with one possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without departing from the spirit and scope of the invention.

The invention comprises a variety of embodiments, such as a method and apparatus and other embodiments that relate to the basic concepts of the invention.

In a typical mobile computing device, an LCD display or other type of display is often used to display user interface information and visual content such as video, images, text, etc. For example, cellular phones, handheld computers and other mobile computing devices often come equipped with an LCD display. Typically, the resolution on such a mobile computing display has been set by the manufacturer at a specific value that does not vary. Often, the resolution is set at a relatively low value to conserve energy, as such mobile computing devices are at many times running on a limited battery energy, and a higher resolution would drain the battery energy faster.

However, the invention provides for dynamic selection of display resolution in a mobile computing device. The invention dynamically selects the display resolution based on at least one of a media type of the visual media file and an image height and an image width of the visual media file to be displayed and based on an energy level of the mobile computing device, as further explained below. The invention may also allow the user to define preferences that govern the display resolution settings for visual content files, thus overriding the manufacturer settings. These preferences may be applied subject to the energy level of the mobile computing device, as one example.

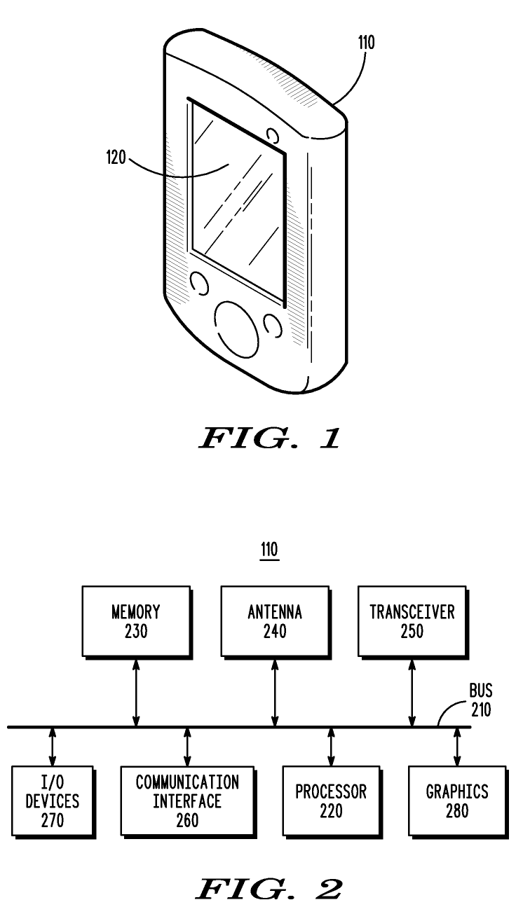

FIG. 1 illustrates an exemplary diagram of a mobile computing device 110 in accordance with a possible embodiment of the invention. The mobile computing device 110 may be any mobile or portable computing device, including a mobile telephone, cellular telephone, a wireless radio, a portable computer, a laptop, an MP3 player, satellite radio, satellite television, etc. The mobile computing device 110 may have a display 120, which may be an LCD display, for example.

FIG. 2 illustrates a block diagram of an exemplary mobile computing device 110 in accordance with a possible embodiment of the invention. The exemplary mobile computing device 110 may include a bus 210, a processor 220, and a memory 230. The bus 210 may permit communication among the components of the mobile computing device 110. The mobile computing device 110 may include other optional elements such as an antenna 240, a transceiver 250, a communication interface 260, input/output (J/O) devices 270, and a graphics device 280, although these elements may not be necessary to practice the invention.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM which may include a conventional ROM device or another type of static storage device that stores static information and instructions for processor 220.

Transceiver 240 may include one or more transmitters and receivers. The transceiver 240 may include sufficient functionality to interface with any network or communication station and may be defined by hardware or software in any manner known to one of skill in the art. The processor 220 is cooperatively operable with the transceiver 240 to support operations within the network.

Input/output devices I/O devices) may include one or more conventional input mechanisms that permit a user to input information to the mobile communication device 110, such as a microphone, touchpad, keypad, keyboard, mouse, pen, stylus, voice recognition device, buttons, etc. Output devices 270 may include one or more conventional mechanisms that output information to the user, including a display, one or more speakers, a storage medium, such as a memory, magnetic or optical disk, disk drive, and printer, etc., and/or interfaces for the above. The display may typically be an LCD display as used on many conventional mobile computing devices.

Additionally, as mentioned above, the mobile computing device 110 may include or have associated with it a second display, either LCD or non-LCD type, functioning as an output device 270. This second display may be built into the device in addition to an LCD display, or may be added to the mobile computing device prior to or after purchase of the mobile computing device by the consumer. In any case, the invention will interact with the display in order to dynamically select the resolution for the display. The programming necessary to accomplish this functionality may be stored in the memory of the mobile computing device at the time of manufacture, or may be loaded into the memory at a later time.

The mobile computing device 110 may perform functions in response to processor 220 by executing sequences of instructions or instruction sets contained in a computer-readable medium, such as, for example, memory 230. Such instructions may be read into memory 230 from another computer-readable medium, such as a storage device or from a separate device via a communication interface.

During use, the user may initiate the display of some visual content, such as a video clip, a still photo, a document, or a web page, among others. Each time a visual content file is to be displayed, the processor 220 may dynamically select a resolution to use to display the visual content from a visual media file on the screen of the mobile computing device. The visual media file may be any type of visual content including still images, such as photos, video clips or video streams, documents, etc. These may include specific media types such as but not limited to JPEG, BMP, GIF, MP4, WMV, MOV, PDF, DOC, XLS, PPT, etc. The processor 220 may determine the type of visual content contained within the visual media file. The processor 220 may determine an image height and an image width of visual content to be displayed. In the case of a mobile computing device with a graphics device 280, the graphics device 280 may perform the steps described above in place of the processor 220. The processor 220 or the graphics device 280 may select a display resolution to match the resolution of the visual content in the file. Alternately, the processor 220 may select a display resolution and then configure the graphics device 280 to activate a display resolution to match the resolution of the visual content in the file.

The mobile computing device 110 illustrated in FIGS. 1-2 and the related discussion are intended to provide a brief, general description of a suitable communication and processing environment in which the invention may be implemented. Although not required, the invention will be described, at least in part, in the general context of computer-executable instructions, such as program modules, being executed by the mobile computing device 110, such as a mobile telephone, or a television set-top box. Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations, including cellular devices, mobile communication devices, personal computers, hand-held devices, multi-processor systems, microprocessor-based or programmable consumer electronics, and the like.

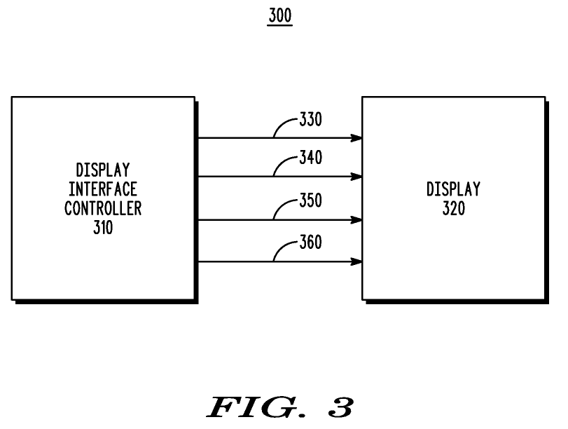

FIG. 3 illustrates an exemplary block diagram of a display system 300 of a mobile computing device in accordance with a possible embodiment of the invention. The system 300 may include a display interface controller 310 and a display device 320, and interface signals between these elements that may include a data bus 330, a clock 340, one or more optional control signals 350, and a communication bus 360. The display interface controller 310 may be part of a processor 220 or a graphics device 280 as in a mobile computing device 110. During operation of the display 320, the display interface controller 310 directs the operation of the display 320 via the clock 340 and optional control signals 350 and drives the data to the display 320 over the data bus 330. The clock 340 and control signals 350 define the active timing and active resolution of the display 320. The communication bus 360 provides a means for the display interface controller 310 to issue commands to the display 320 and for the display 320 to send information back to the display interface controller 310. The commands sent over the communication bus 360 may configure the operation of the display 320, including aspects such as the active resolution. In addition, the display 320 may provide information to the display interface controller 310 over the communication bus 360, such as the resolution settings that the display 320 can support.

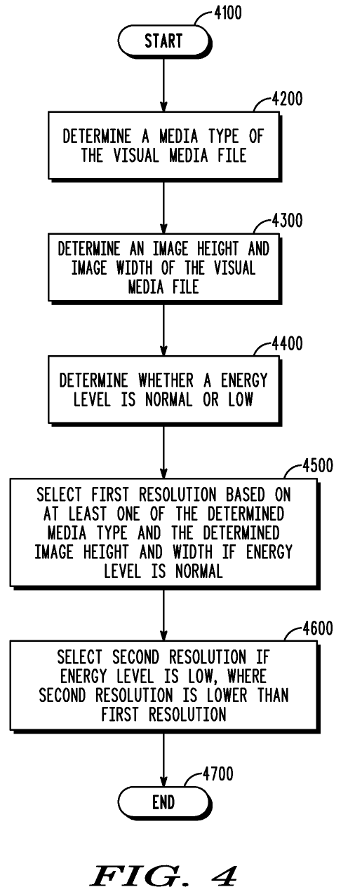

FIG. 4 illustrates an exemplary flow diagram of a method of dynamically selecting one of a plurality of resolutions to be used as the active display resolution to display visual content on a screen of a mobile computing device in accordance with a possible embodiment of the invention. The process starts at 4100. In this example, at 4200, the media type of the visual content file is determined. Any method of determining the visual media type may be used with the embodiments. One such method is that metadata attached to the visual media file is read. The metadata may include the media type of the visual content contained in the visual media file. Alternately, the file type or filename extension of the visual media file may indicate the media type.

At 4300, an image height and an image width of the visual content in the file are determined. Any method of determining the image height and image width may be used with the embodiments. One such method is that metadata attached to the visual media file is read. The metadata may include the image height and image width of the visual media file. For example, a JPEG still image may have attached thereto metadata including the image height and image width, which may be read by the processor 220. The process may omit one of step 4200 or step 4300, and only determine one of either the media type or the image height and image width of the visual media file.

At 4400, it is determined whether an energy level of the mobile computing device is at a normal level or a low level. This may be accomplished by the processor 220 checking an energy level of a battery, for example. The embodiments may have a threshold energy level below which the energy level will be considered to be at a low level, and at or above which the energy level may be considered to be at a normal level. The embodiments may also allow a range of energy levels, more than 2, for purposes of determining the energy state and selecting the display resolution for the system. Additionally, the embodiments may a normal energy level to be an energy level within a particular energy level range, and a low energy level to be an energy level within a second and lower energy level range.

At 4500, the processor will select a first resolution for display of the visual media file based on at least one of the determined visual media type and the determined image height and image width, if the energy level has been determined to be at a normal level. The selected resolution may be the same as the determined image height and the image width, or may be set at another value, but in either event will be based on at least one of the determined media type and the determined image height and image width, as further explained below.

At 4600, a second resolution is selected for display of the visual content file if the energy level of the mobile computing device is determined to be at a low level. At 4700, the display resolution selection process ends and the processor activates the selected resolution for the display. The second resolution used for the low energy level is a lower resolution than the first resolution level used for the normal energy level. The display energy is proportional to the number of pixels, and thus a higher resolution requires more energy. Further, a higher resolution requires more memory to store the display frame buffer and means that more pixels have to be transferred to the display for every displayed frame, and these also contribute to higher energy consumption.

By displaying the visual content at a lower resolution when the energy level of the mobile computing device is low, the embodiments of the invention conserve energy for when the energy is most needed. Further, when the energy level is at a normal level, the visual content file may be displayed at a higher resolution for an improved viewing experience.

An embodiment may include a mobile computing device having a display device, such as an LCD or other display type, and this display device may have a default or native resolution with 1024×768 pixels, known as XGA. Such a display device can be controlled to display XGA-resolution images, or images with a different number of pixels. Where visual content with a different number of pixels are displayed, they can be displayed at XGA by scaling up or scaling down to fit the screen, or they may be displayed at a lower resolution.

Thus, embodiments of the invention may receive an XGA-resolution still image that is determined to have a media type of JPEG, having an image height and an image width of 1024×768 and this image height and image width may be read from the metadata or otherwise determined. If it is then determined that the energy level of the mobile computing device is at a normal level, a first resolution is selected for display of the still image. This first resolution may be XGA at 1024×768, for example. If the JPEG still image has an image height and width greater than 1024×768, the image may be scaled down to be displayed at 1024×768.

During the resolution selection process, if the energy level is determined to be a low energy level, the processor will select a lower resolution for display to conserve energy. For example, if the normal energy resolution is selected to be 1024×768, the low energy resolution may be selected to be 800×600 or 640×480, for example.

Further, the particular resolutions for normal energy conditions and low energy conditions may be selected based on user-defined display criteria. For example, as shown below in chart 1, the user may indicate that all visual content files having an image height and an image width of 800×600 and higher be displayed at a resolution of 1024×768 under normal energy conditions, with the images scaled up or down if needed. The user could further indicate that the same visual content files be displayed at a reduced resolution of 640×480 under low energy conditions. Any other reduced resolution could also be selected for display during low energy conditions. The user could further indicate that a visual media file of type MP4, having a determined image height and width of 176×144, as found in a QCIF-resolution video clip, be displayed at a first resolution of 640×480 during normal energy conditions, while being displayed at a second resolution of 352×244 during low energy conditions. Both of these selected resolutions would require scaling up of the video content but would result in different energy consumption and still provide lower energy consumption for the second resolution. The first and second resolutions for visual content files having the various image heights and widths may be preset by the manufacturer, for example, or may be selectable by the user. Where user selectable values are used, values from the examples shown here may be used as the default settings but the user may select different values based on their preferences.

CHART 1

| Visual Content File | | |
|---|---|---|
| Image Height and Width | Normal Energy | Low Energy |
| >1024 × 768 | 1024 × 768 | 640 × 480 |
| | Scale down to fit | |
| 1024 × 768 | 1024 × 768 | 640 × 480 |
| 800 × 600 | 1024 × 768 | 640 × 480 |
| | Scale up to fit | |
| 176 × 144 | 640 × 480 | 352 × 244 |
| (QCIF video clip) | Scale up to fit | Scale up to fit |

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

We claim:

1. A method of dynamically selecting one of a plurality of resolutions to be used as a display resolution to display visual content from a visual media file on a screen of a mobile computing device, comprising:
determining at least one of a media type of the visual media file and an image height and an image width of the visual media file;
determining whether an energy level of the mobile computing device is a normal energy level or a low energy level;
selecting a first one of the plurality of resolutions as the display resolution for display of the visual content file, the first one of the plurality of display resolutions being selected based on the determined at least one of the media type of the visual media file and the image height and the image width of the visual media file, if the energy level is determined to be the normal energy level; and
selecting a second one of the plurality of resolutions as the display resolution for display of the visual content file, if the energy level is determined to be the low energy level,
wherein the first one of the plurality of resolutions is a higher resolution than the second one of the plurality of resolutions.

2. The method of claim 1, wherein determining at least one of the media type of the visual media file and the image height and the image width of the visual media file comprises reading metadata attached to the visual media file.

3. The method of claim 1, wherein selecting the first one of the plurality of display resolutions further comprises scaling the determined image height and image width of the visual media file to match a screen height and a screen width of the screen of the mobile computing device.

4. The method of claim 1, wherein the first one of the plurality of resolutions and the second one of the plurality of resolutions are further selected based on user-defined display criteria.

5. The method of claim 4, wherein the user-defined display criteria includes a desired display resolution for each of a plurality of different visual media file types.

6. The method of claim 5, wherein the desired display resolution may be a different resolution for each of the plurality of different visual media file types.

7. The method of claim 1, wherein the mobile computing device is one of a mobile telephone, a cellular telephone, a wireless radio, a portable computer, a laptop computer, an MP3 player, and a satellite radio.

8. The method of claim 1, wherein the desired display resolution is further selected based on an active application software controlling the display or the status of a communication or data link of the mobile computing device.

9. An apparatus for dynamically selecting one of a plurality of resolutions for display in a mobile computing device, comprising:
a memory that stores a plurality of instructions, the instructions being usable for dynamically selecting the one of a plurality of resolutions to be used as a display resolution to display a visual media file on a screen of the mobile computing device; and
a processor that executes the instructions to:
determine at least one of a media type of the visual media file and an image height and an image width of the visual media file;
determine whether an energy level of the mobile computing device is a normal energy level or a low energy level;
select a first one of the plurality of resolutions as the display resolution for display of the visual media file, the first one of the plurality of display resolutions being selected based on the determined at least one of the media type and the image height and the image width of the visual media file, if the energy level is determined to be the normal energy level; and
select a second one of the plurality of resolutions as the display resolution for display of the visual media file, if the energy level is determined to be the low energy level,
wherein the first one of the plurality of resolutions is a higher resolution than the second one of the plurality of resolutions.

10. The apparatus of claim 9, wherein the processor determines the visual media type and the image height and the image width of the visual media file by reading metadata attached to the visual media file.

11. The apparatus of claim 9, wherein the processor selects the first one of the plurality of display resolutions by scaling the first one of the plurality of display resolutions from the determined image height and image width of the visual media file to match a screen height and a screen width of the screen of the mobile computing device.

12. The apparatus of claim 9, wherein the processor further selects the first one of the plurality of resolutions and the second one of the plurality of resolutions based on user-defined display criteria.

13. The apparatus of claim 12, wherein the user-defined display criteria includes a desired display resolution for each of a plurality of different visual content file types.

14. The apparatus of claim 13, wherein the desired display resolution may be a different resolution for each of the plurality of different visual media file types.

15. The apparatus of claim 9, wherein the mobile computing device is one of a mobile telephone, a cellular telephone, a wireless radio, a portable computer, a laptop computer, an MP3 player, and a satellite radio.

16. The apparatus of claim 9, wherein the desired display resolution is further selected based on an active application software controlling the display or the status of a communication or data link of the mobile computing device.

17. A mobile computing device, comprising:
a memory that stores a plurality of instructions, the instructions being usable for dynamically selecting one of a plurality of resolutions to be used as a display resolution to display a visual media file on a screen of the mobile computing device; and
a processor that executes the instructions to:
determine at least one of a media type of the visual media file and an image height and an image width of the visual media file;
determine whether an energy level of the mobile computing device is a normal energy level or a low energy level;
select a first one of the plurality of resolutions as the display resolution for display of the visual media file, the first one of the plurality of display resolutions being selected based on the image height and image width of the visual media file, if the energy level is determined to be the normal energy level; and
select a second one of the plurality of resolutions as the display resolution for display of the visual content file, if the energy level is determined to be the low energy level,
wherein the first one of the plurality of resolutions is a higher resolution than the second one of the plurality of resolutions.

18. The mobile computing device of claim 17, wherein the processor determines an image height and image width of the visual media file by reading metadata attached to the visual media file.

19. The mobile computing device of claim 17, wherein the processor selects the first one of the plurality of display resolutions by scaling the first one of the plurality of display resolutions from the determined image height and image width of the visual media file to match a screen height and a screen width of the screen of the mobile computing device.

20. The mobile computing device of claim 17, wherein the processor further selects the first one of the plurality of resolutions and the second one of the plurality of resolutions based on user-defined display criteria.

21. The mobile computing device of claim 20, wherein the user-defined display criteria includes a desired display resolution for each of a plurality of different visual content file types.

22. The mobile computing device of claim 17, wherein the mobile computing device is one of a mobile telephone, a cellular telephone, a wireless radio, a portable computer, a laptop computer, an MP3 player, and a satellite radio.
